(19) United States
(12) Patent Application Publication
(10) Pub. No.: US 2004/0127638 A1
(43) Pub. Date: Jul. 1, 2004

(54) Acrylonitrile block copolymer and method for producing the same

(75) Inventors: Lizamma Mathew, Hsinchu (TW); Kuo-Chen Shih, Kaohsiung (TW); Hsi-Hsin Shih, Taichung (TW); Joung-Yei Chen, Hsinchu (TW); Rong-Ming Ho, Taichung (TW); Chu-Chieh Lin, Taichung (TW)

Correspondence Address: SUGHRUE MION, PLLC, 2100 PENNSYLVANIA AVENUE, N.W., SUITE 800, WASHINGTON, DC, 20037, US

(73) Assignee: INDUSTRIAL TECHNOLOGY RESEARCH INSTITUTE

(21) Appl. No.: 10/600,644

(22) Filed: Jun. 23, 2003

(30) Foreign Application Priority Data
Dec. 31, 2002 (TW) 91138103

(51) Int. Cl. C08G 61/00; C08G 63/00; C08G 18/10

(52) U.S. Cl. 524/839; 528/61

(57) ABSTRACT

An acrylonitrile block copolymer and method for producing the same. A macroinitiator is produced by halogenating the terminal group of the polyester. The macroinitiator then contacts with acrylonitrile (AN) monomer or its derivative in the presence of the metal catalyst and solvent mixture to produce a block copolymer composed of a polyacrylonitrile, and a polyester.

### BACKGROUND OF THE INVENTION

1. Field of the Invention

The present invention relates in general to acrylonitrile block copolymers and a method for producing the same. In particular, the present invention relates to acrylonitrile block copolymer with narrow molecular weight distribution and method for producing the same.

2. Description of the Related Art

Block copolymers are a special class of polymer in which each molecule consists of two or more distinct segments of simple polymers (blocks) joined in some arrangement. Depending on the selection of the monomers and the synthetic method adopted or invented, block copolymers, in theory, can be prepared with a plurality of segments or blocks having different pre-selected properties, e.g., polarity, glass transition temperature, solubility, and refractive index, etc. Actually, one of the most useful attribute of block copolymers is their ability to combine the disparate properties of different materials into a single material, oftentimes demonstrating unique physical properties different from individual polymer molecules.

An additional feature of block copolymers is their ability to localize at the interface of two materials thereby modifying the chemical and physical bond between the two. In order to localize in this manner, the block copolymer must be comprised of segments which have a specific chemical or physical affinity for the respective materials. This feature has been employed for compatibilizing blend, improving dispersion and improving adhesion.

In order to achieve the above-mentioned properties, each block in the block copolymer has to have a specific affinity for a specific material and controlled chain length of demand. If the chain length of each block copolymer is close to each other, that is, narrow molecular weight distribution (Mw/Mn), the demand effects are more obvious.

It was mentioned in the prior art that block copolymers with narrow molecular weight distribution can be self-assembled into nanostructures or microstructures such as well-ordered arrays of spheres, cylinders or lamellae etc., depending on the volume fraction and physical properties of the components comprising the polymer chain. It is anticipated that the successful development of the science and technology of molecular self-assembly for producing functional mesostructures could have a revolutionary impact in many aspects of the industry. It includes those concerned with pharmaceuticals, cosmetics, biomaterials, lubricants, separation membranes, adhesives, thin films, coatings, catalysts and catalyst supports, micro-fabrication, microelectronic, and nano-scale electronics and photonics.

Due to the above-mentioned advantages, the industry is in a continuous effort to search for the efficient methods for the synthesis of block copolymers, especially the block copolymers combining segments with physical properties being unable achieved in the prior art.

Polyacrylonitrile (PAN) is an important class of polymeric material with several specific physical properties; such as low gas permeability, good chemical resistance and good compatibility with high polarity material etc. If PAN and other polymers with different physical properties are chemically interconnected, it is anticipated that the resulting block copolymers can demonstrate some unique properties different from the individual polymer segments, especially, if both blocks can be adjusted easily and the molecular weight distribution of the polymers is narrower.

Therefore, the industry is in a need to search for the preparation of block copolymers of polyacrylonitrile and other segment, especially polyester. The novel block copolymer of polyacrylonitrile and polyester has a variety of applications. It can be used as an efficient surfactant, compatibilizing agent and dispersant. For example, the block copolymer can improve the blending of two incompatible polymers, such as the polyester and polyacrylonitrile. Moreover, the block copolymer with a narrow molecular weight distribution can undergo a process to self-assemble into specific nano-structures so as to be applied to the field of photoelectric material, etc.

In the prior art, the block copolymers of polyacrylonitrile and addition polymer like polystyrene and polyacrylates, or polyester are mainly prepared using traditional free radical polymerization, as stated in JP 07018517, JP 07207108, U.S. Pat. No. 3,262,995 and U.S. Pat. No. 4,180,528. This method results in a broad molecular weight distribution, poor control of molecular weight, and a high homo-polymer content. Therefore, the obtained copolymers are not able to demonstrate the full unique properties as expected.

In recent years a controlled radical polymerization method, atom transfer radical polymerization (ATRP), has been reported in the prior art. It is claimed that ATRP is able to control the radical polymerization of styrene, acrylates, methacrylates and their derivatives, resulting in predetermined molecular weight and narrow molecular weight distribution. However, in the prior art, the efficient controlled polymerization of acrylonitrile by ATRP is limited to several specific initiators. Only the initiators containing nitrile group or sulfonyl chloride (SO₂Cl), (eg. 2-bromopropionitrile, 2-chloropropionitrile (see Macromolecules, 1997, vol. 30, p. 6398.), and 4-methoxy benzene sulfonyl chloride (see U.S. Pat. No. 5,886,118)), result inefficient control of the polymerization. The macromoinitiators Br-[PEHA]-Br and Br-[PBA]-Br disclosed in Polymer preprint, vol. 37, p. 272, 1996, result in poor control of the polymerization. The molecular weight distribution of the resulting polymer is too wide (PDI>3.6).

### SUMMARY OF THE INVENTION

It is therefore an object of the present invention to provide a block copolymer with a narrow molecular distribution composed at least of an addition polymer, polyacrylonitrile, and a polyester.

Another object of the present invention is to use the polyester with a terminal group containing halogen as a macroinitiator, contact with acrylonitrile (AN) monomer in the presence of the metal catalyst and solvent mixture to produce a block copolymer, composed of an addition polymer, polyacrylonitrile, and a polyester.

It is still another object of the present invention to provide a macromolecule with terminal group containing halogen by modifying the terminal group of the polyester, such as PCL. After which the macromolecule contacts with acrylonitrile monomer in the presence of the metal catalyst and a solvent mixture to produce the block copolymer composed of polyacrylonitrile and polyester.

### DETAILED DESCRIPTION OF THE INVENTION

In order to achieve the foregoing objects, the present invention provides a block copolymer consists of a segment with the formula of -A-(B)ₘ-, wherein A includes a polyester block Y and a linking group and is represented by the following formula:

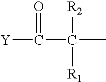

wherein Y is a radical remaining after removal of the hydrogen atom of a terminal hydroxy (OH) functional group of a polyester; R₁ and R₂ represent alkyl, aryl, alkylaryl, aralkyl, aminoalkyl, alkylamino, alkoxy, or alkoxy aryl group; B represents acrylonitrile or its methyl derivative monomer; and m is an integer from 20 to 10,000. Y can be a polyester prepared from:

(1) a dicarboxylic acid which can be terephthalic acid, isophthalic acid, 1,4-cyclohexanedicar-boxylic acid or adipic acid;

(2) a diol which can be ethylene glycol, 1,4-butanediol, 1,4-cyclohexanedimethanol, neo-pentyl glycol, dietylene glycol, 2,2,4,4-tetramethyl-1,3-cyclobutanediol or 1,6-hex-anediol; and

(3) a copolyester of caprolactone and a material selected from the group consisting of terephthalic acid, isophthalic acid, 1,4-cyclohex-anedicarboxylic acid, adipic acid, ethylene glycol, 1,4-butanediol, 1,4-cyclohexanedime-thanol, neopentyl glycol, 2,2,4,4-tetramethyl-1,3-cyclobutanediol, diethylene glycol and 1,6-hexanediol and mixtures thereof.

Specifically, the polyester block Y can be polycaprolactone, polyvalerolactone, polybutyrolactone, polylactide or their copolymers.

Specifically, the above-mentioned A can be

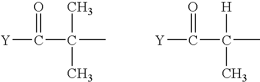

In the above-mentioned block copolymer, segment A has a number average molecular weight (Mn) of about 5×10²-3×10⁵, preferably 10³-10⁵, and a PDI (Mw/Mn) of about 1.05-2, preferred 1.05-1.5.

In the above-mentioned block copolymer, segment (B)ₘ has a number average molecular weight (Mn) of about 10³-3×10⁵, preferred 10³-10⁵.

The above-mentioned block copolymer has a PDI of about 1.05-2, preferred 1.05-1.5.

The method for forming the acrylonitrile block copolymer is described herein.

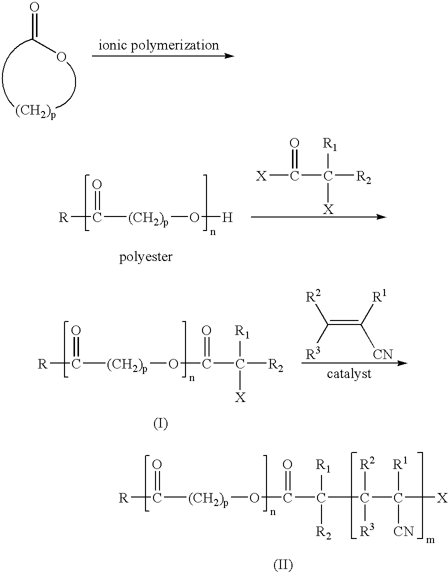

In one of the above-mentioned formula, X are the same or different and can be halogens, preferably Cl or Br; R¹, R² and R³ are the same or different and can be H or CH₃; R can be any alkyl, aryl, alkoxy, or arylalkoxy group; p is an integer from 4 to 7; n is an integer from 20 to 2000. Specifically, R can be benzyloxyl (C₆H₅CH₂O), or isopropyloxyl (((CH₃)₂CH)O).

In the present invention, the preparation of the polyester with terminal group containing halogen, i.e. polymer (I), consists of two steps: (1) synthesis of polyester containing terminal hydroxy (OH) functional group(s) mainly by ionic polymerization; and (2) replacement of the OH terminal group with the functional group containing halogen. The displacement reaction can be any suitable organic reaction performed by mixing the polyester and an organic compound, or a Lewis basic compound in a solvent, and halogenating the terminal group of polyester with an organic halide. For example, the reaction between the polyester and an organic halide, such as 2-bromoisobutyryl bromide, 2-chloroisobutyryl chloride, or the one with the following formula (IV) or (V), results in the above-mentioned polyester with the terminal group containing halogen atom(s), in the presence of a suitable proton abstraction compound such as triethylamine or pyridine.

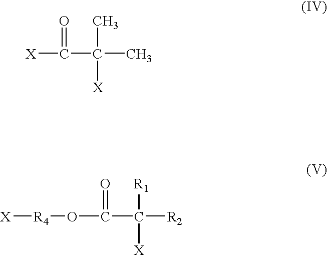

In formulas IV and V, X are the same or different and can be halogen, R₄ can be alkyl, aryl, alkylaryl, aralkyl, aminoalkyl, alkylamino, alkoxy, or alkoxy aryl group.

Then, the polyester with halogen terminal group (I) is used as macroinitiator to contact with acrylonitrile (AN) monomer in the presence of the metal catalyst and solvent mixture to produce the block copolymer, composed of polyacrylonitrile and polyester with a narrow molecular weight distribution. The metal catalyst is consisted of a metal compound MX_{q}, and organic ligand(s). The metal compound MX_{q}, and organic ligand(s) can be (pretreated and then mixed with reaction components for the polymerization reaction, or added in situ for the reaction. For the metal compound MX_{q}, M is a transition metal such as Fe, Co, Ni, Cu, Rh, Ir, Pd, Pt, Ru or Re; X is a halogen or pseudohalogn such as —NCS, —NCO, —SCN, —CN, —N₃, —SO₄, carboxylate group, or —NO₂; q is the valence of the transition metal. A preferred organic ligand is, for example, bipyridine and its derivatives, triphenylphosphine and its derivatives, 2-pyridyl diphenylphosphine and its derivatives, or other organic compounds containing multiple nitrogen atoms, such as PMDETA (pentamethyldiethylenetriamine), and the molar ratio of organic ligand to metal is 1-4. The suitable solvent for the polymerization reaction can be ethylene carbonate, propylene carbonate, butylene carbonate, dimethyl formamide (DMF) and hexafluoro isopropanol, etc.

Using the above-mentioned polymerization methods, the molecular weight of the block copolymer of polyacrylonitrile and polyester in this invention can be well controlled. Its molecular weight distribution is narrow, and the chain length of each block can be controlled also. Therefore the block copolymer can be used in the field of cross-linking agent, coating, surfactant, compatibilizer, dispersant, acrylic fiber, filtration separation membrane, or polyelectrolyte.

The block copolymers of this invention have narrow molecular weight distribution, one high glass transition temperature (Tg) and one low glass transition temperature (Tg), therefore, they can be applied to cross-linking agent and coating, such as hot melt adhesive and pressure sensitive adhesive.

The block copolymers of this invention can improve the blending of two incompatible polymers, such as the polyester and polyacrylonitrile. The block copolymers of this invention can also help to well disperse incompatible materials, such as organic and inorganic compounds, to improve physical or chemical properties of the incompatible materials.

Moreover, the block copolymer with a narrow molecular weight distribution of this invention can undergo a process to self-assemble into specific nano-structures such as nanoporous array substrate, so as to be applied to photoelectric material, photonic crystal and biomedical material, such as drug delivery systems etc.

### EXAMPLE

### Example 1

### Synthesis of Poly(ε-caprolactone) (PCL)

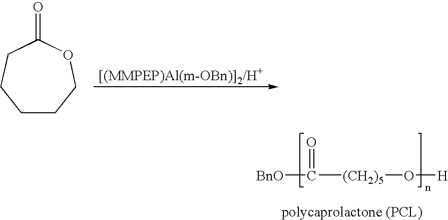

ε-caprolactone (2.1 ml, 20 mmol) was added into a toluene solution of [(MMPEP)Al(μ-OBn)]₂ (0.161 g, 0.10 mmol) (Bn: Benzyl). The reaction mixture was vigorously stirred in an oil bath at 53° C. for 1 hour. After the reaction was quenched by the addition of an excess acetic acid solution (0.35 N), the polymer was precipitated into n-heptane. The white precipitate was washed with hexane three times and dried under vacuum to give a white solid (81%). The PCL product obtained had a number average molecular weight (Mn) of 10,600, determined by ¹H NMR, and PDI of 1.08.

### Example 2

### Bromination of the Terminal Group of PCL

2-bromoisobutyryl bromide (0.05 ml, 0.4 mmol) was added into dry dichloromethane (5 ml; CH₂Cl₂) solution of PCL (1 g, 0.08 mmol, Mn=10600, PDI 1.08) and triethylamine (NEt₃, 0.06 ml, 0.044 mmol) The mixture was stirred overnight at room temperature. After filtration, the filtrate was added into hexane to precipitate out the product, followed by washing with heptane, and vacuum dry to give the product (III), terminal group brominated polycaprolactone. The product obtained was 100% brominated, determined by ¹H NMR.

The bromination of PCL was described below:

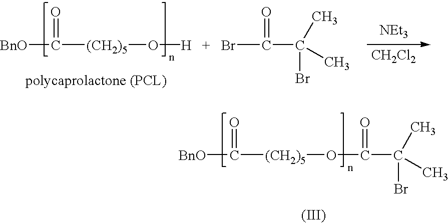

### Example 3

### Synthesis of the Block Copolymer of Polycaprolactone and Polyacrylonitrile

4 mg of Cu(I)Br, 9 mg of bipyridine, 1 g of macromolecular initiator of brominated-PCL (Mn=10,600, PDI=1.08) obtained from Example 1, 8 g of ethylene carbonate, and 5.22 ml of acrylonitrile were placed in a flask. After four freeze-pump-thaw cycles to remove the oxygen, the solution was vigorously stirred for 2.5 hours at 100° C., followed by immediately cooling to room temperature. The solution was then mixed with DMF (10 ml), and added into water to precipitate out the polymer. After washing with THF and vacuum dry, the polymer was subject to GPC and NMR measurement. The polymer has a PDI of 1.3 and yield of 4 g, determined by GPC. Mn of PCL block is 10,600 and Mn of PAN block is 31,000, determined by ¹H NMR.

The preparation of the block polymer follows the equation described below:

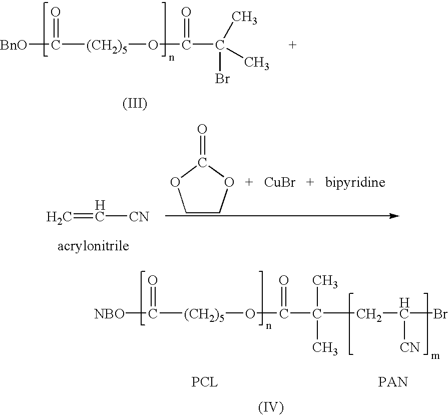

### Example 4

### Synthesis of the Block Copolymer of Polycaprolactone and Polyacrylonitrile

8 g of ethylene carbonate, 15.6 mg of Cu(I)Br (0.11 mmol), 34 mg of bipyridine (0.22 mmol), 2 g of macromolecular initiator of brominated-PCL(Mn=5,500, 0.36 mmol, PDI=1.1) and 4 ml of acrylonitrile (61.2 mmol) were added in a flask. After four freeze-pump-thaw cycles to remove the oxygen, the solution was vigorously stirred for 5 hours at 100° C., followed by immediately cooling to room temperature. The solution was then mixed with DMF (10 ml), and added into water to precipitate out the polymer. After washing with THF and vacuum dry, the polymer was subject to GPC and NMR measurement. The polymer has a PDI of 1.09 and yield of 3.5 g, determined by GPC, and a glass transition temperature (Tg) of −66° C. and 209° C., determined by DSC (differential scanning calorimeter). Mn of PCL block was 5,500 and DP is 48 and Mn of PAN block was 6,576 determined by ¹H NMR and DP is 123.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A acrylonitrile block copolymer comprising -A-(B)ₘ-, wherein A is represented by the following formula: 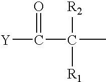
wherein
Y is a radical remaining after removal of the hydrogen atom of a terminal hydroxy (OH) functional group of a polyester;
R₁ and R₂ represent alkyl, aryl, alkylaryl, aralkyl, aminoalkyl, alkylamino, alkoxy, or alkoxy aryl groups;
B represents acrylonitrile or its methyl derivative monomer; and
m is an integer from 20 to 10,000.

2. The acrylonitrile block copolymer as claimed in claim 1, wherein the polyester radical Y is polycaprolactone, polyvalerolactone, polybutyrolactone, polylactide or their copolymer radical.

3. The acrylonitrile block copolymer as claimed in claim 1, wherein B is methacrylonitrile monomer.

4. The acrylonitrile block copolymer as claimed in claim 1, wherein A is 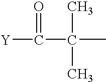
or

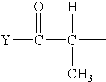

5. The acrylonitrile block copolymer as claimed in claim 1, wherein a number average molecular weight (Mn) of A is about 10³-10⁵, and a number average molecular weight (Mn) of (B)ₘ is about 10³-3×10⁵.

6. The acrylonitrile block copolymer as claimed in claim 1, wherein PDI of A is about 1.05-2.0.

7. The acrylonitrile block copolymer as claimed in claim 1, wherein PDI of A is about 1.05-1.5.

8. The acrylonitrile block copolymer as claimed in claim 1, wherein a number average molecular weight of the acrylonitrile block copolymer is about 1.05-2.0.

9. The acrylonitrile block copolymer as claimed in claim 1, wherein a number average molecular weight of the acrylonitrile block copolymer is about 1.05-1.5.

10. The acrylonitrile block copolymer as claimed in claim 1, wherein the acrylonitrile block copolymer is represented by the following formula: 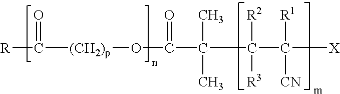
wherein R¹, R² and R³ are the same or different and are H or CH₃; R is any alkyl, aryl, alkoxy, or arylalkoxy group; p is an integer from 4 to 7; n is an integer from 20 to 2000.

11. A cross-linking agent, surfactant, compatibilizer or dispersant comprising the acrylonitrile block copolymer as defined in claim 1.

12. A method for producing an acrylonitrile block copolymer, the acrylonitrile block copolymer comprising -A-(B)ₘ, wherein (B)ₘ is a polyacrylonitrile block and A includes a polyester block and a linking group linking the polyester block and the polyacrylonitrile block, wherein B is an acrylonitrile or its derivative monomer, the method comprising:
halogenating a terminal group of a polyester to form a macroinitiator; and
contacting the macroinitiator with acrylonitrile or its derivative monomers by controlled radical polymerization.

13. The method for producing the acrylonitrile block copolymer as claimed in claim 12, wherein the macroinitiator is 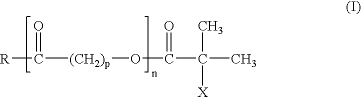
wherein R is benzyloxyl (C₆H₅CH₂O), or isopropyloxyl (((CH₃)₂CH)O); p is an integer from 4 to 7; n is an integer from 20 to 2000.

14. The method for producing the acrylonitrile block copolymer as claimed in claim 12, wherein the macroinitiator (I) is prepared by mixing the polyester and an organic compound, or a Lewis basic compound in a solvent, and is halogenated reacting with an organic halide represented by the following formula: 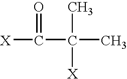
wherein, X is halogen and the two X are the same or different.

15. The method for producing the acrylonitrile block copolymer as claimed in claim 14, wherein the organic compound used to prepare the macroinitiator is triethylamine (NEt₃) or pyridine.

16. The method for producing the acrylonitrile block copolymer as claimed in claim 12, wherein the polyester block is polycaprolactone, polyvalerolactone, polybutyrolactone or polylactide block.

17. The method for producing the acrylonitrile block copolymer as claimed in claim 12, wherein the macroinitiator is prepared by mixing the polyester and an organic compound, or a Lewis basic compound in a solvent, and is halogenated with a halide represented by the following formula: 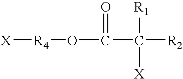
wherein X is halogen, the two X are the same or different, and R₄ is alkyl, aryl, alkylaryl, aralkyl, aminoalkyl, alkylamino, alkoxy, or alkoxy aryl group.

18. The method for producing the acrylonitrile block copolymer as claimed in claim 12, wherein the controlled radical polymerization used to react the macroinitiator with the acrylonitrile or its derivative monomers is atom transfer radical polymerization (ATRP).

19. The method for producing the acrylonitrile block copolymer as claimed in claim 12, wherein the acrylonitrile monomer's derivative is methacrylonitrile.

20. The method for producing the polyacrylonitrile block copolymer as claimed in claim 12, wherein a number average molecular weight (Mn) of the polyacrylonitrile block is about 10³-3×10⁵.

21. The method for producing the polyacrylonitrile block copolymer as claimed in claim 12, wherein the macroinitiator contacts with acrylonitrile or its derivative monomers in the presence of a mixture including a metal catalyst and a solvent.

22. The method for producing the polyacrylonitrile block copolymer as claimed in claim 21, wherein the metal catalyst is consisted of a metal compound MX_{q} and an organic ligand, M is a transition metal, X is a halogen or pseudohalogn, q is the valence of the transition metal.

23. The method for producing the polyacrylonitrile block copolymer as claimed in claim 22, wherein M is Fe, Co, Ni, Cu, Rh, Ir, Pd, Pt, Ru or Re.

24. The method for producing the polyacrylonitrile block copolymer as claimed in claim 22, wherein the pseudohalogn is —NCS, —NCO, —SCN, —CN, —N₃, —SO₄, carboxylate group, or —NO₂.

25. The method for producing the polyacrylonitrile block copolymer as claimed in claim 22, wherein the organic ligand is bipyridine, triphenylphosphine, 2-pyridyl diphenylphosphine or an organic compound containing multiple nitrogen atoms, and a molar ratio of organic ligand to metal is 1-4.

26. The method for producing the polyacrylonitrile block copolymer as claimed in claim 25, wherein the organic compound containing multiple nitrogen atoms is PMDETA (pentamethyldiethylenetriamine).

27. The method for producing the polyacrylonitrile block copolymer as-claimed in claim 21, wherein the solvent is ethylene carbonate, propylene carbonate, butylene carbonate, dimethyl formamide (DMF) or hexafluoro isopropanol.
